(19) United States
(12) Patent Application Publication
(10) Pub. No.: US 2012/0271482 A1
(43) Pub. Date: Oct. 25, 2012

(54) Information Processing Apparatus and Semiconductor Storage Drive

(75) Inventor: Hisao Tsukazawa, Oume-shi (JP)

(73) Assignee: KABUSHIKI KAISHA TOSHIBA

(21) Appl. No.: 13/523,596

(22) Filed: Jun. 14, 2012

Related U.S. Application Data
(63) Continuation of application No. 12/330,278, filed on Dec. 8, 2008.

(30) Foreign Application Priority Data
Dec. 27, 2007 (JP) 2007-338083

(51) Int. Cl. G05D 23/00

(52) U.S. Cl. 700/300

(57) ABSTRACT

An information processing apparatus includes a case having a side wall formed with an exhaust port; a cooling fan configured to suction air inside the case and discharge the air through the exhaust port; a first circuit board on which a main processor is mounted and disposed in the case; and a second circuit board disposed in the case to align with the first circuit board along the side wall. Mounted on the second circuit board is a memory device, a memory controller that controls the memory device, and a temperature sensor. The memory controller performs a process to lower a temperature of the memory device based on a temperature detected by the temperature sensor.

### CROSS-REFERENCE TO RELATED APPLICATIONS

This application is a Continuation Application based upon and claims the priority from U.S. application Ser. No. 12/330,278, now abandoned, and is based upon and claims the benefit of priority from Japanese Patent Application No. 2007-338083, filed on Dec. 27, 2007, the entire content of which are incorporated herein by reference.

### BACKGROUND

1. Field

One embodiment of the present invention relates to an information processing apparatus and a semiconductor storage drive.

2. Description of the Related Art

There is proposed a memory module provided with a memory package, a temperature sensor, and a temperature detection circuit. An example of such memory module is disclosed in JP-A-2007-257062.

The memory module includes a memory package mounted on a printed circuit board, a temperature sensor that measures the temperature of the memory package, and a temperature detection circuit that compares the temperature measured by the temperature sensor with a temperature set beforehand. Accordingly, the memory module can measure the temperature of the memory package with the temperature sensor and detect whether or not the measured temperature exceeds the set temperature with the temperature detection circuit.

However, in the known memory module, a target object whose temperature is to be detected by the temperature sensor is a memory package. For this reason, in case where a component serving as a heat source other than the memory package or a region with a higher temperature than a region where the memory package is mounted is present on the printed circuit board, there is a problem that the temperature of such a component or region cannot be detected by the temperature sensor.

### SUMMARY

One of objects of the present invention is to provide an information processing apparatus and a semiconductor storage drive capable of measuring the temperature of a region which is located between a semiconductor memory and a control unit and whose temperature is higher than those of other regions of a printed circuit board.

According to a first aspect of the present invention, there is provided an information processing apparatus including: a nonvolatile semiconductor storage device that is used as an external storage device, the device including: a printed circuit board; a nonvolatile semiconductor memory that is mounted on the printed circuit board; a memory controller that is mounted on the printed circuit board and controls the nonvolatile semiconductor memory; and a temperature sensor that is mounted on the printed circuit board and detects temperature within the nonvolatile semiconductor storage device; and a main controller that performs a process to lower the temperature of the nonvolatile semiconductor storage device based on the temperature detected by the temperature sensor provided in the nonvolatile semiconductor storage device.

According to a second aspect of the present invention, there is provided a semiconductor storage drive that is provided within an information processing apparatus to be used as an external storage device, the device including: a printed circuit board; a nonvolatile semiconductor memory that is mounted on the printed circuit board; a memory controller that is mounted on the printed circuit board and controls the nonvolatile semiconductor memory; and a temperature sensor that is mounted on the printed circuit board between the nonvolatile semiconductor memory and the memory controller and detects temperature within the nonvolatile semiconductor storage device.

### BRIEF DESCRIPTION OF THE SEVERAL VIEWS OF THE DRAWINGS

A general configuration that implements the various feature of the invention will now be described with reference to the drawings. The drawings and the associated descriptions are provided to illustrate embodiments of the invention and not to limit the scope of the invention.

FIG. 1 is a schematic diagram illustrating the appearance of an information processing apparatus according to a first embodiment of the invention.

FIG. 2 is a plan view illustrating the inside of a main unit of the information processing apparatus.

FIG. 3 is a bottom view illustrating the inside of the main unit of the information processing apparatus.

FIG. 4 is a block diagram illustrating the schematic configuration of the information processing apparatus.

FIG. 5 is a perspective view illustrating an example of the appearance of an SSD.

FIG. 6 is a block diagram illustrating the schematic configuration of the SSD.

FIG. 7 is a flow chart illustrating an operation of the information processing apparatus according to the first embodiment of the present invention.

FIG. 8 is a block diagram showing a general configuration of an information processing apparatus according to a second embodiment of the present invention.

FIG. 9 is a flow chart illustrating an operation of the information processing apparatus according to the second embodiment of the present invention.

FIG. 10 is a flow chart illustrating an operation of an information processing apparatus according to a third embodiment of the present invention.

FIG. 11 is a flow chart illustrating an operation of an information processing apparatus according to a fourth embodiment of the present invention.

FIG. 12 is a flow chart illustrating an operation of an information processing apparatus according to a fifth embodiment of the present invention.

### DETAILED DESCRIPTION

Hereinafter, information processing apparatuses according to embodiments of the invention will be described in detail with reference to the accompanying drawings.

### First Embodiment

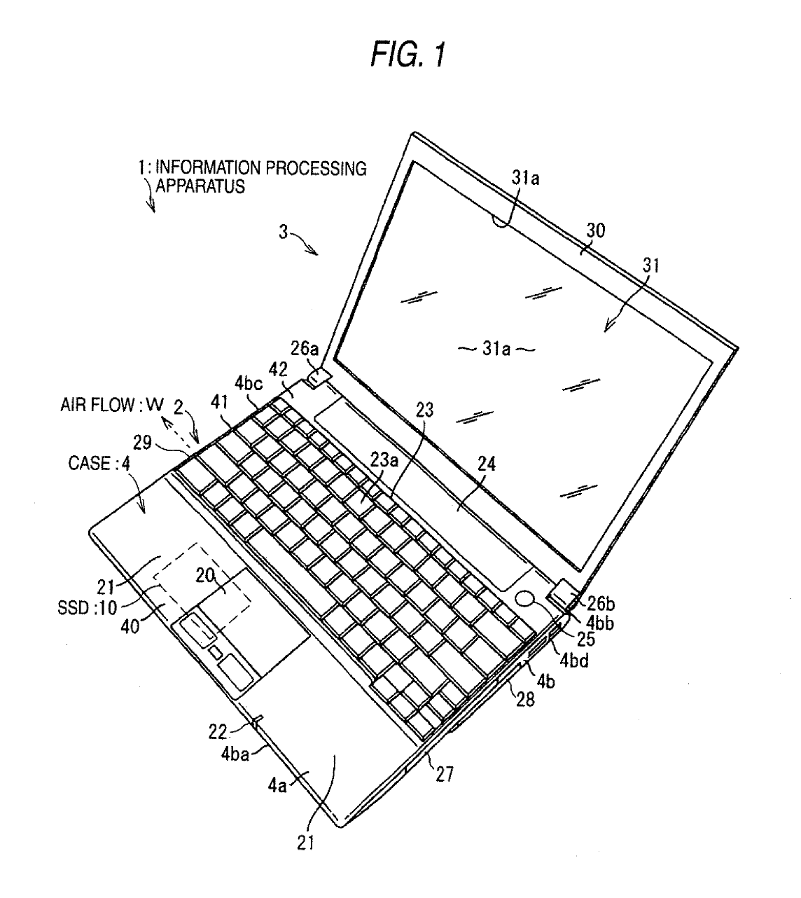

FIG. 1 is a schematic diagram illustrating the appearance of an information processing apparatus according to a first embodiment of the invention. An information processing apparatus 1 is configured to include a main unit 2 and a display unit 3 attached to the main unit 2.

The main unit 2 includes a box-shaped case 4, and the case 4 is provided with an upper wall 4a, a peripheral wall 4b, and a lower wall 4c. The upper wall 4a of the case 4 has a front portion 40, a middle portion 41, and a back portion 42 sequentially from the side near a user who operates the information processing apparatus 1. The lower wall 4c faces a placement surface on which the information processing apparatus 1 is placed. The peripheral wall 4b has a front wall 4ba, a rear wall 4bb, and side walls 4bc and 4bd on the left and right sides.

The front portion 40 includes a touch pad 20 that is a pointing device, a palm rest 21, and an LED 22 that is lighted in synchronization with an operation of each portion of the information processing apparatus 1.

The middle portion 41 includes a keyboard placement portion 23 to which a keyboard 23a capable of inputting alphabetic information and the like is attached.

The back portion 42 includes a battery pack 24 that is detachably attached, a power switch 25 that is provided on the right side of the battery pack 24 in order to supply power to the information processing apparatus 1, and a pair of hinge portions 26a and 26b that is provided on the left and right sides of the battery pack 24 in order to rotatably support the display unit 3.

An exhaust port 29 for exhausting air flow W from the inside of the case 4 to the outside is provided on the left side wall 4bc of the case 4. In addition, an OPTICAL DISK DEVICE (optical disc drive)27 that can read/write data from/into optical storage media, such as a DVD, and a card slot 28 into/from which various kinds of cards 280 are taken are disposed on the right side wall 4bd, for example.

The case 4 is formed by a case cover including a part of the peripheral wall 4b and the upper wall 4a and a case base including a part of the peripheral wall 4b and the lower wall 4c. The case cover is detachably combined with the case base, and an accommodation space is formed between the case cover and the case base. For example, an SSD (solid state drive) 10 as a nonvolatile semiconductor memory is accommodated in the accommodation space. In addition, the SSD 10 will be described in detail later.

The display unit 3 includes a display case 30 having an opening 30a and a display portion 31, such as an LCD, that can display an image on a display screen 31a. The display portion 31 is accommodated in the display case 30, and the display screen 31a is exposed to the outside of the display case 30 through the opening 30a.

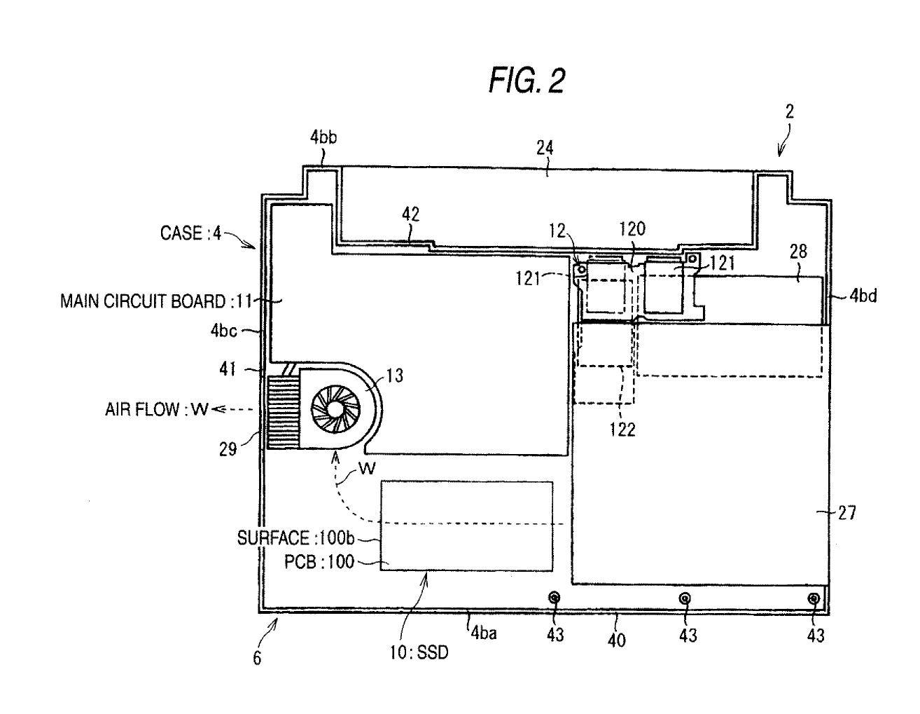

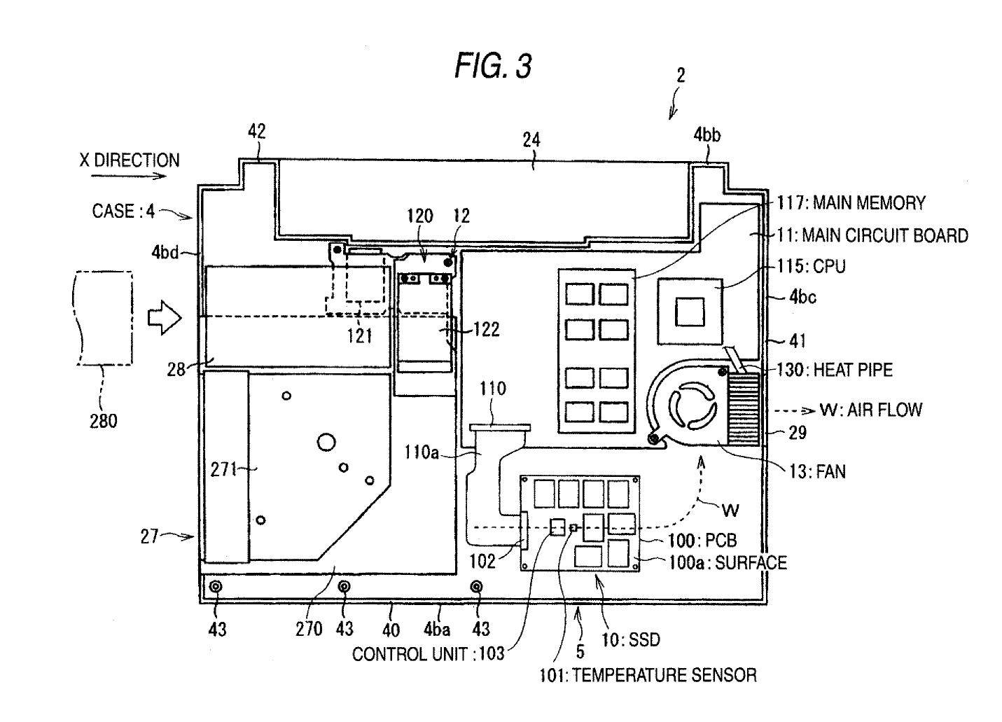

FIG. 2 is a plan view illustrating the main unit 2, and FIG. 3 is a bottom view illustrating the main unit 2 viewed from the below. In order to show the layout in the case 4, the case cover 5 is omitted in FIG. 2 and the case base 6 is omitted in FIG. 3. A plurality of bosses 43 are provided in the case cover 5 and the case base 6.

In the case 4, a main circuit board 11, an extension module 12, and a fan 13 are accommodated in addition to the SSD 10, the battery pack 24, the ODD 27, and the card slot 28.

The main circuit board 11 is a member on which a plurality of electronic components are mounted and which performs a predetermined operation when these electronic components function. In addition, the main circuit board 11 is connected to the SSD 10 through a cable 110a combined with a connector 110 and is connected to the battery pack 24, the ODD 27, the card slot 28, the extension module 12, and the fan 13 through a cable (not shown).

The ODD 27 has a case 270 accommodated in the case 4 and a disk tray 271 which is accommodated within the case 270 so as to be able to be drawn out and on which an optical storage medium is placed.

The shape of the card slot 28 is set by the standard of a PC card slot or ExpressCard (registered trademark) slot, for example.

The extension module 12 includes an extension circuit board 120, a card socket 121 provided in the extension circuit board 120, and an extension module board 122 inserted in the card socket 121. The card socket 121 is based on the standard of Mini-PCI, for example, and examples of the extension module board 122 include a 3G (third generation) module, a TV tuner, a GPS module, a Wimax (registered trademark) module, and the like.

The fan 13 is a cooling unit that cools the inside of the case 4 on the basis of ventilation and exhausts the air in the case 4, as the air flow W, to the outside through the exhaust port 29. In addition, one end of a heat pipe 130 is provided between the fan 13 and the exhaust port 29 and the other end of the heat pipe 130 is provided to be connected to a CPU 115 (not shown). The heat pipe 130 emits evaporative latent heat when the operating fluid provided thereinside evaporates at a side of the CPU 115, which is a heating portion, to become vapor and then the vapor moves through the pipe toward the exhaust port side, which is a low-temperature portion, to be condensed. The condensed operating fluid flows back to the heating portion.

The SSD 10 includes a printed circuit board (PCB) 100. A temperature sensor 101, a connector 102, a control unit (memory controller) 103, and the like are mounted on a surface 100a of the PCB 100. The SSD 10 is accommodated in the case 4 such that the control unit 103 is located at the upstream side of the air flow W, which flows from the inside of the case 4 to the outside due to the fan 13, and the temperature sensor 101 is located at the downstream side of the air flow W. In addition, the connector 102 that electrically connects the SSD 10 and the main circuit board 11 with each other is disposed at the more upstream side of the air flow W, which flows from the inside of the case 4 to the outside, than the control unit 103.

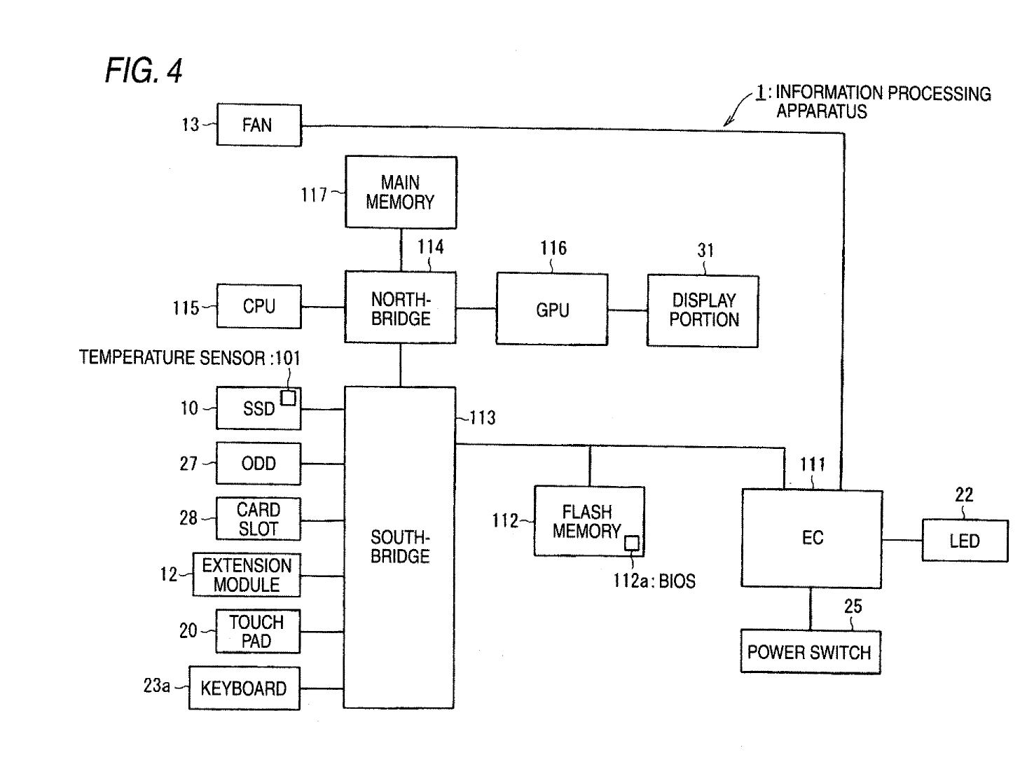

FIG. 4 is a block diagram illustrating the schematic configuration of an information processing apparatus. In addition to the SSD 10, the extension module 12, the fan 13, the touch pad 20, the keyboard 23a, the LED 22, the power switch 25, the ODD 27, the card slot 28, and the display portion 31 described above, he information processing apparatus 1 includes an EC (embedded controller) 111 that is an embedded system for controlling each portion, a flash memory 112 that stores a BIOS (basic input output system) 112a, a southbridge 113 that is an LSI (large scale integration) chip and functions as various buses and I/O controller, a northbridge 114 that controls the connection among a CPU(central processing unit) 115 that is an LSI chip and is to described later, a GPU (graphic processing unit) 116, a main memory 117, and various kinds buses, the CPU 115 for performing operation processing of various signals, the GPU 116 that performs operation processing of image signals and performs display control, and the main memory 117 in which reading and writing are performed by the CPU 115.

In addition, the EC 111, the flash memory 112, the southbridge 113, the northbridge 114, the CPU 115, the GPU 116, and the main memory (main storage device) 117 are electronic components mounted on the main circuit board 11.

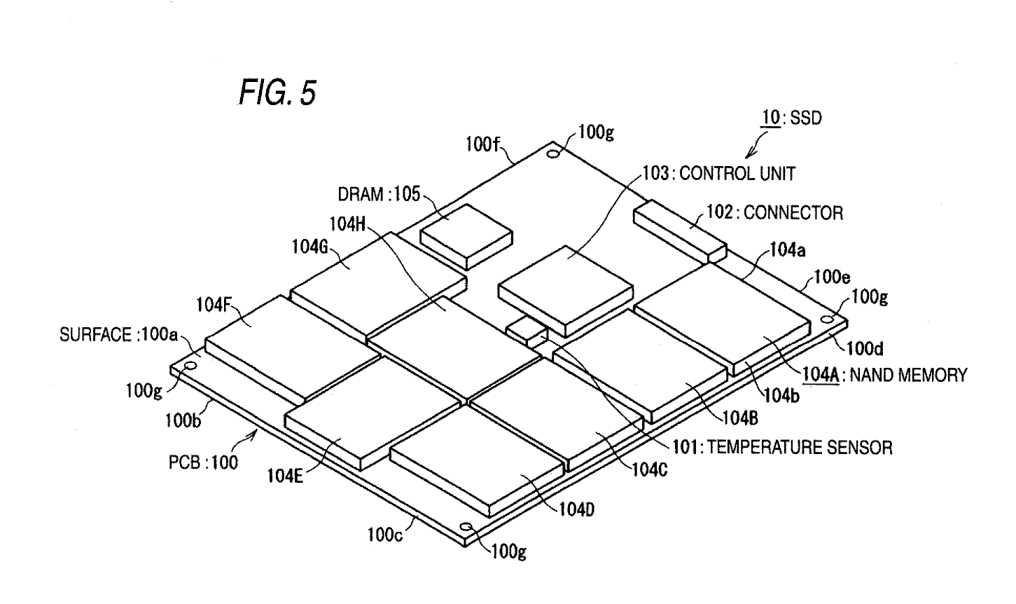

FIG. 5 is a perspective view illustrating an example of the appearance of the SSD. The SSD 10 includes the PCB 100 with surfaces 100a to 100f and is provided with the temperature sensor 101, the connector 102, the control unit 103, eight NAND memories 104A to 104H, and a DRAM 105 which are mounted on the surface 100a of the PCB 100. This SSD 10 is an external storing device storing data or programs which are inerasable even the SSD 10 is powered off. Although not having any driving mechanism such as a magnetic drive such a conventional hard disk drive, a head or the like, this SSD 10 is a drive including a nonvolatile semiconductor memory which is operable as a starting drive of the information processing apparatus 1, which is capable of storing programs such as OS (Operating system), data prepared based on execution by a user or software, etc. in memory regions of 8 NAND memories 104A to 104H, which are mounted on the PCB 100, in a readable/writable manner for a long time.

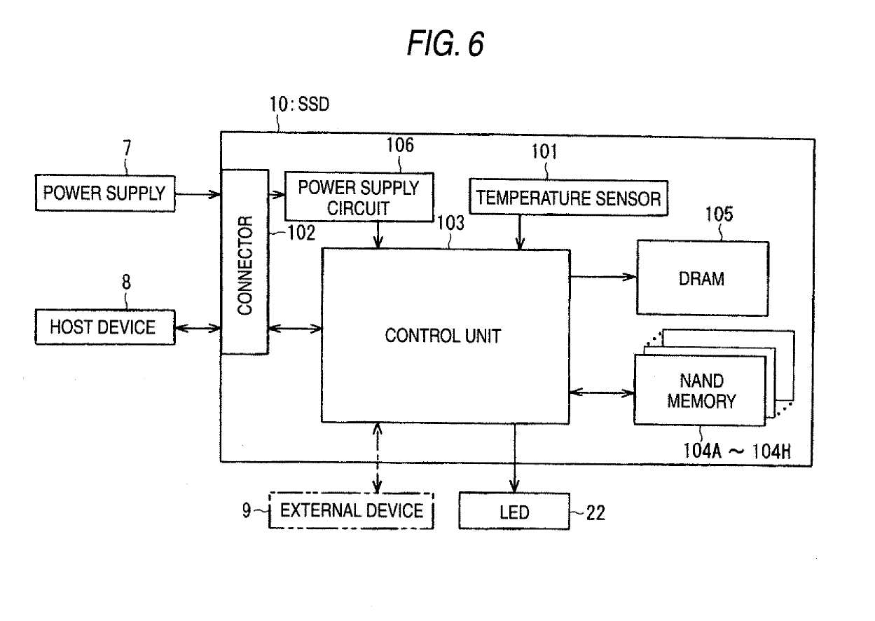

FIG. 6 is a block diagram illustrating the schematic configuration of the SSD. The control unit 103 is connected to the temperature sensor 101, the connector 102, the eight NAND memories 104A to 104H, the DRAM 105, and a power supply circuit 106. In addition, the control unit 103 is connected to a host device 8 through the connector 102 so as to be connected to an external device 9 as needed.

A power supply 7 is the battery pack 24 or an AC adaptor (not shown). For example, DC 3.3 V is supplied to the power supply circuit 106 through the connector 102. In addition, the power supply 7 supplies power to the entire information processing apparatus 1.

The host device 8 is the main circuit board 11 in the present embodiment, and the control unit 103 and the southbridge 113 mounted on the main circuit board 11 are connected to each other. Between the southbridge 113 and the control unit 103, transmission and reception of data are performed on the basis of the serial ATA specification, for example.

The external device 9 is another information processing apparatus different from the information processing apparatus 1. The external device 9 is connected to the control unit 103 of the SSD 10 detached from the information processing apparatus 1 on the basis of the RS-232C standard, for example, and has a function of reading data stored in the NAND memories 104A to 104H.

The PCB 100 has the same outer size as a 1.8 inch type or 2.5 inch type HDD (hard disk drive), for example. In addition, in the present embodiment, the outer size of the PCB 100 is equivalent to the 1.8 inch type. In addition, the PCB 100 has a plurality of through holes 100g used to fix the PCB 100 to the case 4.

The temperature sensor 101 is provided between the control unit 103 and the NAND memories 104A to 104H, which serve as heat sources, on the PCB 100. In the example shown in FIG. 5, the temperature sensor 101 is provided near the middle of the PCB 100 so as to be surrounded by the control unit 103 and the NAND memories 104A to 104H and measures the temperature at the position. The measurement temperature measured by the temperature sensor 101 is transmitted to the control unit 103 as temperature information. In addition, although a semiconductor temperature sensor using a characteristic that a voltage of a PN-junction portion of a semiconductor changes with temperature is used in the present embodiment, temperature sensors based on other methods, such as a thermistor, may also be used.

In the case when the SSD 10 is operating, the temperature measured by the temperature sensor 101 provided at the position is 50 degrees Celsius to 60 degrees Celsius, for example, and is higher by about 10 degrees Celsius than those in the other regions of the PCB 100.

The control unit 103 controls operations of the NAND memories 104A to 104H. Specifically, the control unit 103 controls reading/writing of data from/into the NAND memories 104A to 104H in response to the request from the main circuit board 11 as the host device 8. The data transfer rate is 100 MB/sec at the time of reading of data and 40 MB/sec at the time of writing of data, for example.

The controller 103 acquires temperature information from the temperature sensor 101 at specified periods and lowers response to the host device when measured temperature indicated by the temperature information exceeds a preset threshold. The operation to lower the response refers to an operation to limit some of processing power of the SSD 10 and may include, for example, lowering of a transfer rate when data read out of the NAND memories 104A to 104H are transferred to the host device 8, lowering of a transfer rate between the controller 103 and the NAND memories 104A to 104H, etc.

When the measured temperature exceeds the threshold, the controller 103 outputs an alert signal, as information indicating the fact, to the host device 8. Alternatively, the controller 103 may output the temperature information itself, instead of the alert signal, to the host device 8.

Then controller 103 writes the acquired temperature information, along with its acquisition data and time, in predetermined addresses of the NAND memories 104A to 104H.

Each of the NAND memories 104A to 104H has an outer shape with a long side and a short side and the thickness is 3 mm, for example. The NAND memories 104A to 104H are asymmetrically mounted on the PCB 100. That is, in the example shown in FIG. 5, four NAND memories 104A to 104D of the NAND memories 104A to 104H are disposed in a uniform state so that the long sides are approximately parallel, and the other four NAND memories 104E to 104H are disposed in a combination state so that the short sides and the long sides face each other. The NAND memories 104E to 104H may be disposed on the surface 100b of the PCB 100.

Each of the NAND memories 104A to 104H is a nonvolatile semiconductor memory having a storage capacity of 16 GB, for example, and is an MLC (multi level cell)-NAND memory (multi-value NAND memory) capable of recording two bits on one memory cell. Although the rewritable number of times of the MLC-NAND memory is generally smaller than that of an SLC (single level cell)-NAND memory, it is easy to make the storage capacity large. In addition, the NAND memories 104A to 104H have the characteristics that a period for which data can be stored changes with the set environmental temperature.

The NAND memories 104A to 104H store data written by the control of the control unit 103 and store the temperature information and the acquisition date as temperature history.

The DRAM 105 is a buffer that temporarily stores data when reading/writing of data from/into the NAND memories 104A to 104H is performed by the control of the control unit 103.

The connector 102 has a shape based on the serial

ATA specification, for example. In addition, the control unit 103 and the power supply circuit 106 may be connected to the host device 8 and the power supply 7 by separate connectors, respectively.

The power supply circuit 106 converts DC 3.3 V supplied from the power supply 7 into DC 1.8 V and 1.2 V, for example, and supplies these three kinds of voltages to portions of the SSD 10 so as to match driving voltages of the portions.

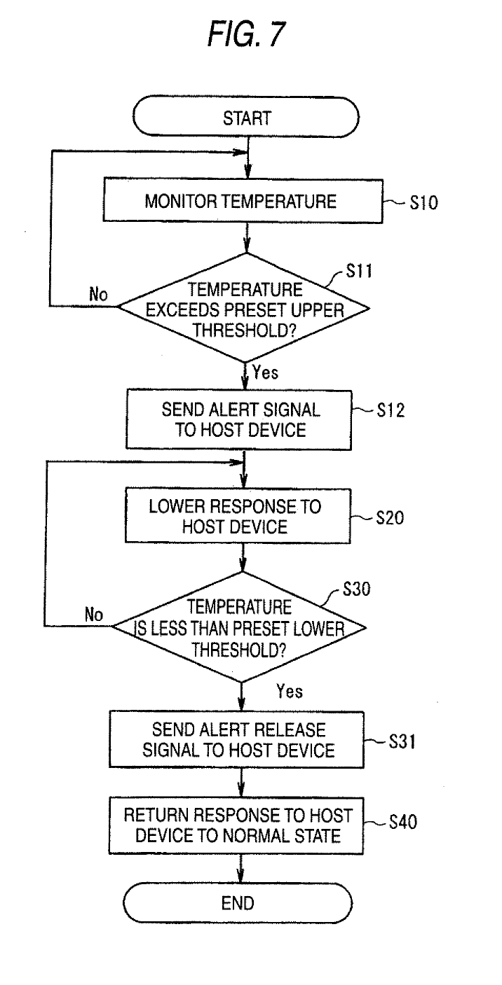

Hereinafter, an operation of the information processing apparatus according to the first embodiment will be described with reference to a flow chart illustrated in FIG. 7.

First, when a user presses the power switch 25, the EC 111 that has detected the pressing of the power switch 25 starts supply of power from the power supply 7 to each portion of the information processing apparatus 1. Then, the EC 111 starts the information processing apparatus 1 on the basis of the BIOS 112a.

Then, when the information processing apparatus 1 is started, the user performs an operation on the information processing apparatus 1 by using the touch pad 20 and the keyboard 23a while viewing the display screen 31a of the display portion 31.

Then, when the information processing apparatus 1 receives the user's operation, the information processing apparatus 1 performs a predetermined operation in response to the operation. For example, in the case where the CPU 15 of the information processing apparatus 1 receives an operation for displaying data stored in the SSD 10 on the display portion 31, the CPU 115 orders the SSD 10 to read data. Then, the control unit 103 of the SSD 10 reads the data from the NAND memories 104A to 104H and transmits the data to the GPU 116 through the southbridge 113 and the northbridge 114. Then, the GPU 116 displays the data as an image on the display portion 31.

While the information processing apparatus 1 is performing the above operation, the temperature sensor 101 of the SSD 10 measures the temperature at the position where the temperature sensor 101 is provided.

Then, the control unit 103 acquires the measurement temperature measured by the temperature sensor 101, as temperature information, at a predetermined period (S10). The control unit 103 stores the acquired temperature information and acquisition date and time in predetermined addresses of the NAND memories 104A to 104H as temperature history.

Next, the controller 103 determines, based on the acquired temperature information, whether or not the measured temperature exceeds a preset upper threshold (S11).

If the controller 103 determines that the measured temperature does not exceed the upper threshold (No in Step S11) , the process returns to Step S10 where the controller 103 continues to monitor temperature by means of the temperature sensor 101. On the other hand, if the controller 103 determines that the measured temperature exceeds the upper threshold (Yes in Step S11), the controller 103 outputs an alert signal to the host device 8 (Step S12). Upon receiving the alert signal, the host device 8 informs a user that the measured temperature for the SSD 10 exceeds the upper threshold by, for example, changing a lighting state of the LED 22 or displaying an alert message on the display unit 31.

Then, the controller 103 lowers its own response to the host device 8 (Step S20).

Next, the controller 103 determines whether or not the measured temperature is less than a preset lower threshold (Step S30) . If the controller 103 determines that the measured temperature is not less than the lower threshold (No in Step S30), the process returns to Step S20 where the controller maintains the response-lowered state.

On the other hand, if the controller 103 determines that the measured temperature is less than the lower threshold (Yes in Step S30), the controller 103 outputs an alert release signal to the host device 8 (Step S31) . Upon receiving the alert release signal, the host device 8 informs the user that the alert is released by means of the LED 22, the display unit 31, etc.

Then, the controller 103 returns its own response to the host device 8 to the normal state before lowering of the response (Step S40).

According to the first embodiment of the present invention, since the temperature sensor 101 is provided between the controller 103 and the NAND memory 104H, it is possible to measure temperature of a region having temperature higher than those of other regions on the PCB 100.

In addition, since the controller 103 of the SSD 10 lowers its own response to the host device 8 if the measured temperature exceeds the upper threshold, it is possible to suppress the measured temperature to be less than the upper threshold and suppress variation of a data sustaining period of the SSD 10.

In addition, since the controller 103 of the SSD 10 outputs the alert signal to the host device 8 if the measured temperature exceeds the upper threshold, the host device 8 can recognize that the measured temperature for the SSD 10 exceeds the upper threshold and perform a process coping with the alert signal.

In addition, by storing a temperature history in the NAND memories 104A to 104H, it is possible to confirm environmental temperature under conditions where the SSD 10 is used, in a time series. In addition, the temperature history can be read not only by the controller 103 but also the southbridge 113 in performing a process to lower the temperature of the SSD 10, for example.

### Second Embodiment

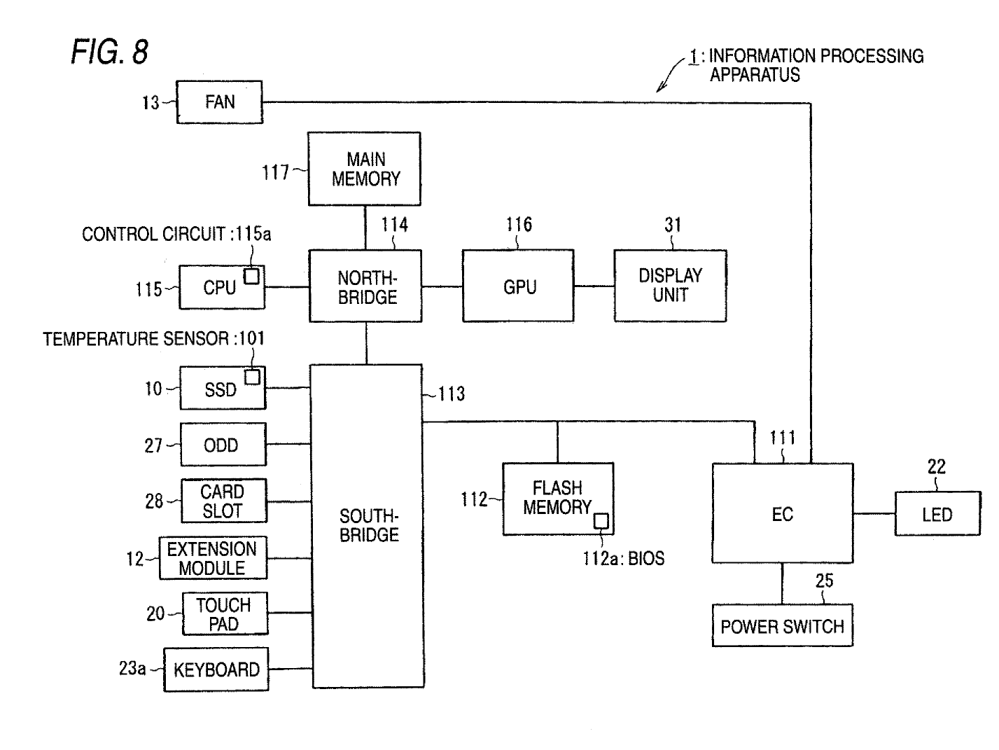

FIG. 8 is a block diagram showing a general configuration of an information processing apparatus according to a second embodiment of the present invention. Unlike the first embodiment in which the SSD 10 performs the operation to suppress its own measured temperature to be less than the upper threshold, in the second embodiment, the host device 8 connected the SSD 10 performs a cooling operation to cool the SSD 10 based on temperature information outputted from the SSD 10.

In other words, the information processing apparatus 1 of the second embodiment has the same configuration and function as the information processing apparatus 1 of the first embodiment except that a CPU 115 of the second embodiment has a control circuit 115a to control a cooling operation.

The control circuit 115a makes a blow rate of a fan 13 larger than that in a normal operation for cooling the SSD 10 based on the temperature information outputted from the SSD 10. In this embodiment, since the temperature information outputted from the SSD 10 serves as the same alert signals alert release signal as the first embodiment, the control circuit 115a increases the blow rate of the fan 13 upon receiving the alert signal from the SSD 10 and returns the blow rate of the fan 13 to the normal level upon receiving the alert release signal. In addition, the control circuit 115a may cause the fan 13 to be switched between ON and OFF.

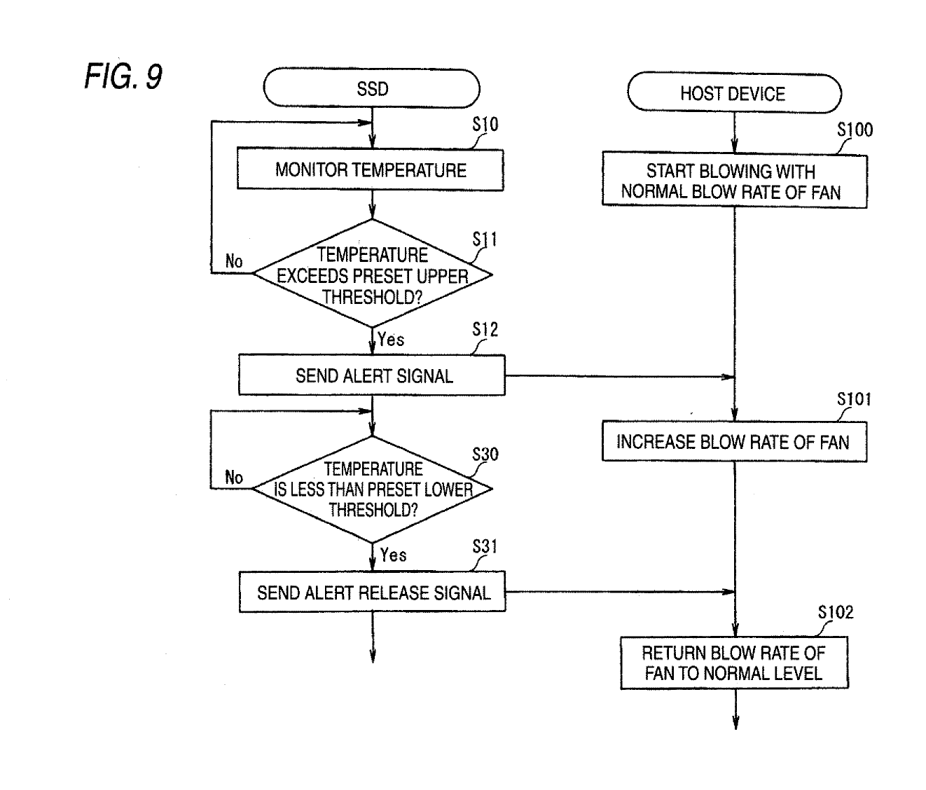

Hereinafter, an operation of the information processing apparatus according to the second embodiment will be described with reference to a flowchart illustrated in FIG. 9.

First, the controller 103 of the SSD 10 monitors the temperature of the SSD 10 by means of the temperature sensor 101 while the information processing apparatus 1 is performing an operation (Step S10). On the other hand, the host device 8 performs an operation at a request by a user and, at the same time, begins to blow with a normal level of blow rate of the fan 13 (Step S100).

Next, the controller 103 determines whether or not temperature measured by the temperature sensor 101 exceeds a preset upper threshold (Step S11). If the controller 103 determines that the measured temperature does not exceed the upper threshold (No in Step S11), the process returns to Step S10. On the other hand, if the controller 103 determines that the measured temperature exceeds the upper threshold (Yes in Step S11), the controller 103 outputs an alert signal to the host device 8 (Step S12).

Next, upon receiving the alert signal from the SSD 10, the control circuit 115a of the CPU 115 increases the blow rate of the fan 13 by means of an EC 111 (Step S101).

Next, the controller 103 determines whether or not the measured temperature is not less than a preset lower threshold (Step S30). If the controller 103 determines that the measured temperature is not less than the lower threshold (No in Step S30), the process returns to Step S20. On the other hand, if the controller 103 determines that the measured temperature is less than the lower threshold (Yes in Step S30), the controller 103 outputs an alert release signal to the host device 8 (Step S31).

Next, upon receiving the alert release signal from the SSD 10, the control circuit 115a returns the blow rate of the fan 13 to the normal level by means of the EC 111 (Step S102).

According to the second embodiment of the present invention, since the host device 8 controls the blow rate of the fan based on the temperature information from the SSD 10, it is possible to suppress the measured temperature to be less than the upper threshold and suppress variation of a data sustaining period of the SSD 10.

### Third Embodiment

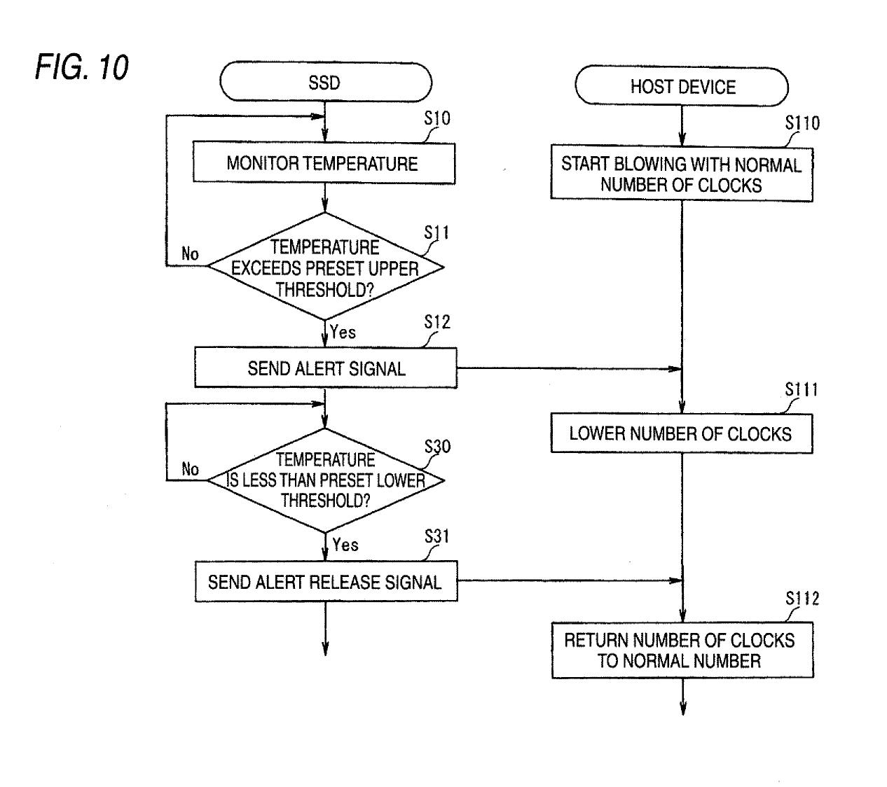

FIG. 10 is a flow chart illustrating an operation of an information processing apparatus according to a third embodiment of the present invention. The control circuit 115a of the third embodiment has the same configuration and function as that of the second embodiment except that the former has a processing power of the host device 8 to decrease the number of clocks as a cooling operation.

The control circuit 115a starts an operation of the host device 8 with the normal number of clocks of the CPU 115 (Step S110). Next, upon receiving the alert signal from the SSD 10, the control circuit 115a decreases the number of clocks of the CPU 115 (Step S111) below the normal number. Upon receiving the alert release signal from the SSD 10, the control circuit 115a returns the number of clocks of the CPU 115 to the normal number (Step S112).

In addition, the control circuit 115a may control the number of clocks of either both of the CPU 115 and the GPU 116 or only the GPU 116.

According to the third embodiment of the present invention, since the host device 8 controls the number of clocks based on the temperature information from the SSD 10, it is possible to suppress the measured temperature to be less than an upper threshold and suppress variation of a data sustaining period of the SSD 10.

### Fourth Embodiment

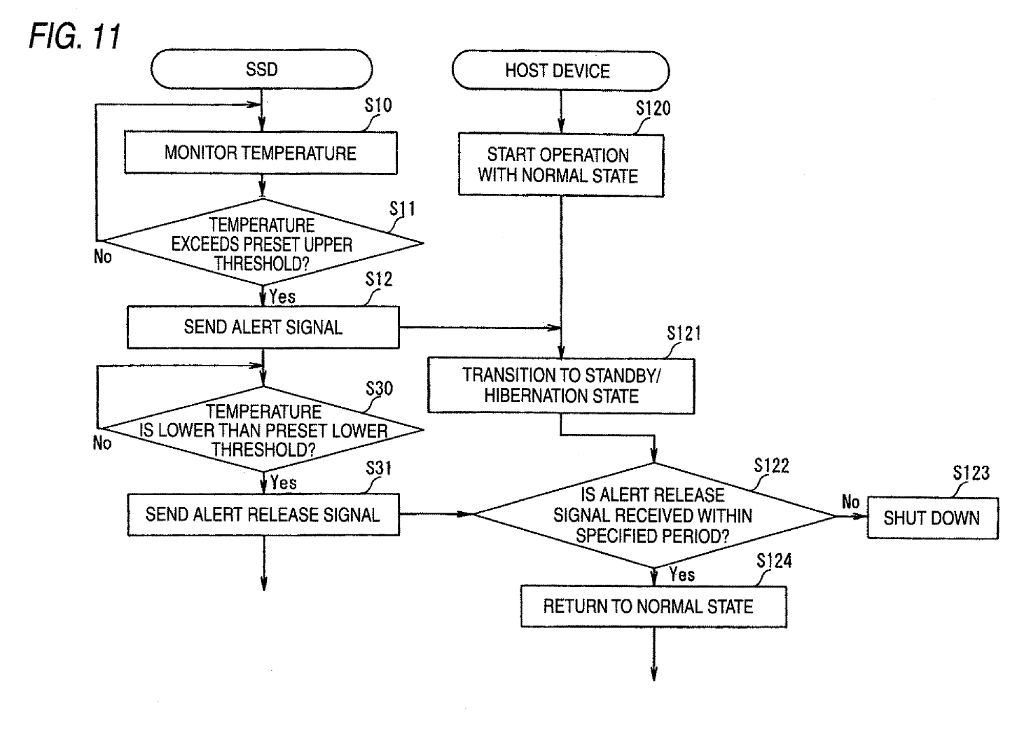

FIG. 11 is a flow chart illustrating an operation of an information processing apparatus according to a fourth embodiment of the present invention. The control circuit 115a of the fourth embodiment has the same configuration and function as that of the second embodiment except that the former transitions the host device 8 into a standby state or a hibernation state for a cooling operation and performs a shut-down process if the SSD 10 is not cooled even by the cooling operation.

The control circuit 115a starts an operation of the host device 8 with a normal system state of the host device 8 (Step S120). Next, upon receiving the alert signal from the SSD 10, the control circuit 115a transitions the host device 8 into the standby state or the hibernation state to stop the host device 8 (Step 121). Then, if the control circuit 115a does not receive the alert release signal within a specified period after the transition (No in Step S122), the control circuit 115a shuts down the host device 8 and then the process is ended (S123).

On the other hand, if the control circuit 115a receives the alert release signal within the specified period (Yes in Step S122), the control circuits 115a transitions the host device 8 from the standby state or the hibernation state into a normal state and restarts the process (S124).

According to the fourth embodiment of the present invention, since the host device 8 controls its system state based on the temperature information from the SSD 10, it is possible to suppress the measured temperature to be less than an upper threshold and suppress variation of a data sustaining period of the SSD 10.

In addition, since the host device 8 performs the shut-down process if the SSD 10 is not cooled, it is possible to prevent the SSD 10 from getting out of order due to environmental temperature.

### Fifth Embodiment

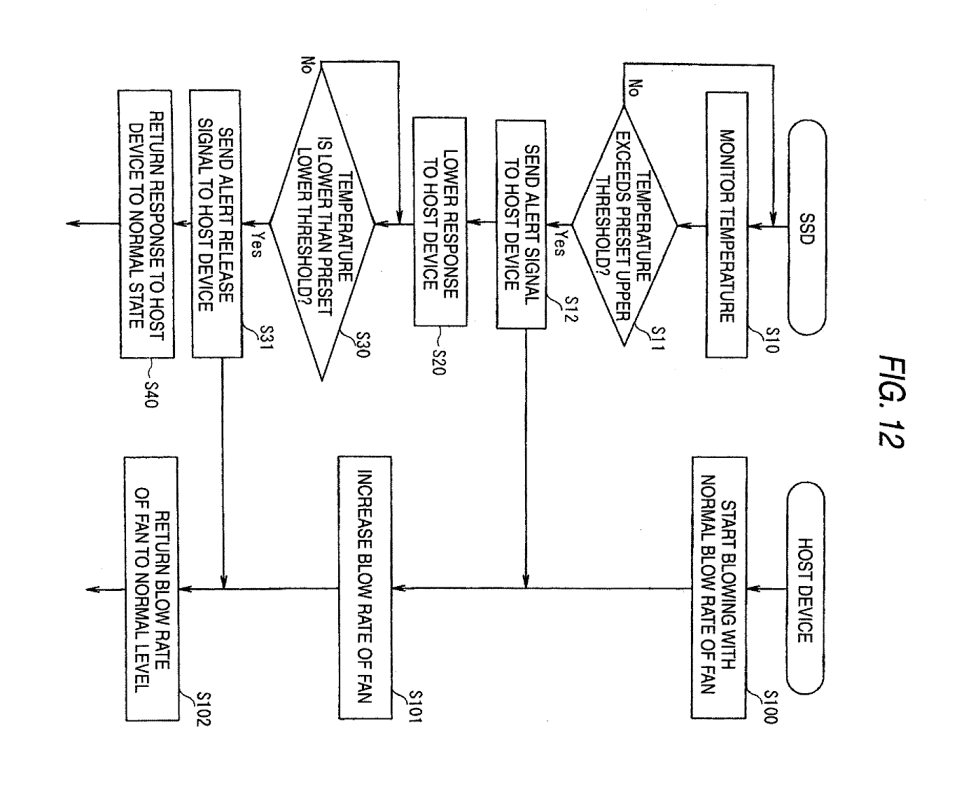

FIG. 12 is a flow chart illustrating an operation of an information processing apparatus according to a fifth embodiment of the present invention. In the information processing apparatus of the fifth embodiment, the SSD 10 performs the operation to lower its own response like the first embodiment and the host device 8 performs the cooling operation by the fan 13 like the second embodiment.

In addition, the control circuit 115a may perform the control of the blow rate of the fan 13 for the cooling operation, the control of the number of clocks and the control of the host device system state, as described in the third and fourth embodiments, respectively, or any 2 or 3 combinations of these controls.

If the controller 103 of the SSD 10 determines, based on monitored temperature (S10), that the measured temperature exceeds a preset upper threshold (Yes in Step S11), the controller 103 sends the alert signal to the host device 8 (S12). In addition, the controller 103 lowers its own response to the host device 8 (S20).

Upon receiving the alert signal, the control circuit 115a increases the blow rate of the fan 13 (S101).

Next, the controller 103 determines whether or not the measured temperature is less than a preset lower threshold (S30). If the controller 103 determines that the measured temperature is less than the lower threshold (Yes in Step S30), the controller 103 outputs the alert release signal to the host device 8 (S31). In addition, the controller 103 returns its own lowered response to the host device 8 to a normal state before being lowered (S40).

Upon receiving the alert release signal, the control circuit 115a changes the blow rate of the fan 13 to the normal level (S102).

According to the fifth embodiment of the present invention, since the SSD 10 performs the cooling operation in cooperation with the host device 8, it is possible to more efficiently cool the SSD 10.

### Other Embodiments

The present invention is not limited to the above-disclosed embodiments but may be modified and altered in various ways without departing from the spirit and scope of the invention. For example, the control circuit 115a of the CPU 115 according to the second to fifth embodiments may be implemented with a program that is stored in the flash memory 112 or the SSD 10 and operates the CPU 115.

In addition, while it has been illustrated in the second to fifth embodiments that the controller 103 of the SSD 10 monitors the temperature, for example, the control circuit 115a of the CPU 115 may monitor the temperature by acquiring the temperature information from the temperature sensor 101 at regular intervals.

As described above in detail, there are provided an information processing apparatus and a nonvolatile semiconductor storage device that are capable to measure the temperature of a region which is located between a semiconductor memory and a control unit and whose temperature is higher than those of other regions of a PCB.

What is claimed is:

1. An information processing apparatus comprising:
a case having a side wall formed with an exhaust port;
a cooling fan configured to suction air inside the case and discharge the air through the exhaust port;
a first circuit board on which a main processor is mounted and disposed in the case;
a second circuit board disposed in the case to align with the first circuit board along the side wall; a memory device that is mounted on the second circuit board;
a memory controller that is mounted on the second circuit board and controls the memory device; and
a temperature sensor that is mounted on the second circuit board;
wherein the memory controller performs a process to lower a temperature of the memory device based on a temperature detected by the temperature sensor.

2. The apparatus of claim 1,
wherein the temperature sensor detects the temperature of at least one of the second circuit board, the memory device and the memory controller.

3. The apparatus of claim 1,
wherein the memory controller controls the fan to increase the air flow from an air flow in a normal state to lower the temperature detected by the temperature sensor.

4. The apparatus of claim 1,
wherein the memory controller stores a history of the temperature detected by the temperature sensor in the memory device.

5. The apparatus of claim 4,
wherein the memory controller reads out the history of the temperature stored in the memory device.

6. The apparatus of claim 1,
wherein the memory controller controls the processor to perform a shut-down process when the temperature detected by the temperature sensor is not lowered to a predetermined temperature in spite of the process to lower the temperature.

7. The apparatus of claim 1,
wherein the memory controller lowers a processing power to lower the temperature detected by the temperature sensor.

8. The apparatus of claim 1,
wherein the memory controller outputs the temperature detected by the temperature sensor to an external device to perform a process to lower the temperature detected by the temperature sensor.

9. The apparatus of claim 1,
wherein the memory device comprises a nonvolatile semiconductor memory.

10. The apparatus of claim 1,
wherein the memory device is a NAND memory.

11. An apparatus comprising:
a case including a side wall having an exhaust port;
a fan configured to suction air inside the case and discharge the air through the exhaust port;
a first circuit board positioned within the case, the first circuit board including a main processor mounted on a surface of the first circuit board; and
a second circuit board positioned within the case and aligned with the first circuit board along the side wall, the second circuit board including a memory device, a temperature sensor and a memory controller mounted on a surface of the second circuit board, the memory controller controls the memory device and performs a process to lower a temperature of the memory device based on a temperature detected by the temperature sensor.

12. The apparatus of claim 11,
wherein the temperature sensor detects the temperature of at least one of the second circuit board, the memory device and the memory controller.

13. The apparatus of claim 11,
wherein the memory controller controls the fan to increase the air flow from an air flow in a normal state to lower the temperature detected by the temperature sensor.

14. The apparatus of claim 11,
wherein the memory controller controls the processor to perform a shut-down process when the temperature detected by the temperature sensor is not lowered to a predetermined temperature in spite of the process to lower the temperature.

15. The apparatus of claim 11,
wherein the memory controller lowers a processing power to lower the temperature detected by the temperature sensor.

16. The apparatus of claim 11,
wherein the memory controller outputs the temperature detected by the temperature sensor to an external device to perform a process to lower the temperature detected by the temperature sensor.

17. An apparatus comprising:
a case including a side wall having an exhaust port;
a cooling unit configured to control airflow inside the case and discharge air through the exhaust port;
a first circuit board positioned within the case, the first circuit board including a main processor mounted on a surface of the first circuit board; and
a second circuit board positioned within the case and aligned with the first circuit board along the side wall, the second circuit board including a memory device, a temperature sensor and a memory controller each mounted on a surface of the second circuit board, the memory controller controls the memory device and performs a process to lower a temperature of the memory device based on a temperature detected by the temperature sensor.
